(19) United States
(12) Patent Application Publication
(10) Pub. No.: US 2023/0181945 A1
(43) Pub. Date: Jun. 15, 2023

(54) FILTRATION COMPONENT WITH A DISPERSING ELEMENT CONTAINER FOR A RESPIRATORY PROTECTIVE DEVICE

(71) Applicant: HONEYWELL INTERNATIONAL INC., Charlotte, NC (US)

(72) Inventors: Hang TIAN, Charlotte, NC (US); Xiaojin HAN, Charlotte, NC (US); En Yi CHEN, Charlotte, NC (US)

(21) Appl. No.: 18/060,905

(22) Filed: Dec. 1, 2022

(30) Foreign Application Priority Data
Dec. 15, 2021 (CN) 202111532612.1

(51) Int. Cl. A62B 23/02; A62B 7/10

(52) U.S. Cl. CPC A62B 23/02; A62B 7/10; A62B 18/025

(57) ABSTRACT

A filtration component for a respiratory protective device is provided. For example, the filtration component includes a filter body and a dispersing element container. In some examples, the dispersing element container includes a tube element fastened to a cover element.

### CROSS-REFERENCE TO RELATED APPLICATIONS

This application claims priority pursuant to 35 U.S.C. 119(a) to Chinese Patent Application No. 202111532612.1, filed Dec. 15, 2021, which application is incorporated herein by reference in its entirety.

### FIELD OF THE INVENTION

Example embodiments of the present disclosure relate generally to respiratory protective devices and, more particularly, to a filtration component with a dispersing element container for respiratory protective devices.

### BACKGROUND

Applicant has identified many technical challenges and difficulties associated with respiratory protective equipment, such as masks. For example, many masks do not provide any mechanism for incorporating dispersing elements.

### BRIEF SUMMARY

In accordance with various embodiments of the present disclosure, a filtration component for a respiratory protective device is provided. In some embodiments, the filtration component comprises a filter body and a dispersing element container.

In some embodiments, the filter body comprises a center wall element and a periphery wall element.

In some embodiments, the dispersing element container comprises a tube element fastened to a cover element. In some embodiments, the tube element is positioned at a distal end of the center wall element. In some embodiments, the cover element is positioned at a proximal end of the center wall element. In some embodiments, the proximal end of the center wall element is opposite to the distal end of the center wall element.

In some embodiments, a filter media element is secured between an inner surface of the periphery wall element and an outer surface of the center wall element.

In some embodiments, the tube element further comprises a tube body and a tube head.

In some embodiments, an outer surface of the tube body is in contact with an inner surface of the center wall element.

In some embodiments, the tube head seals a distal end of the tube body.

In some embodiments, a periphery portion of an inner surface of the tube head is in contact with the distal end of the center wall element.

In some embodiments, the cover element comprises a cover body and a cover head.

In some embodiments, a distal end of the cover body is fastened to a proximal end of the tube body. In some embodiments, the cover head seals a proximal end of the cover body. In some embodiments, the proximal end of the cover body is opposite to the distal end of the cover body. In some embodiments, the proximal end of the tube body is opposite to the distal end of the tube body.

In some embodiments, the distal end of the cover body is secured to the proximal end of the tube body via at least one of an interference fit or an adhesive glue.

In some embodiments, an outer surface of the cover body and a periphery portion of an inner surface of the cover head are in contact with the proximal end of the center wall element.

In some embodiments, the cover head of the cover element defines a plurality of openings.

In some embodiments, the filtration component further comprises a seal film element attached to an outer surface of the cover head of the cover element. In some embodiments, the seal film element covers the plurality of openings.

In some embodiments, the dispersing element container further comprises: a release film element secured to the inner surface of the cover head of the cover element, and a dispersing element disposed in the dispersing element container. In some embodiments, the dispersing element disperses element to a user after the seal film element is removed.

In some embodiments, the release film element comprises microporous material.

In some embodiments, the microporous material comprises polytetrafluoroethylene (PTFE).

In some embodiments, the filtration component further comprises a dispersing element disposed within an inner surface of the tube body of the tube element and between the release film element and the tube head of the tube element.

In some embodiments, the dispersing element comprises fragrance material.

In some embodiments, the filtration component further comprises a near-field communication (NFC) element attached to an inner surface of the periphery wall element.

In some embodiments, the periphery wall element comprises an arc portion, a straight portion connected to the arc portion, and a handle portion protruding from an edge of the straight portion.

In some embodiments, a method for assembling a filtration component for a respiratory protective device is provided.

In some embodiments, the method comprises disposing a tube element through a center wall element of a filter body, disposing a dispersing element within a tube body of the tube element, and securing a cover element to the tube element.

In some embodiments, a tube head of the tube element is in contact with a distal end of the center wall element.

In some embodiments, an inner surface of a cover head of the cover element is in contact with a proximal end of the center wall element.

In some embodiments, the cover element is secured to the tube element via at least one of an interference fit or an adhesive glue.

In some embodiments, prior to securing the cover element to the tube element, the method further comprises attaching a release film element to the inner surface of the cover head of the cover element.

In some embodiments, the method further comprises attaching a seal film element to an outer surface of the cover head of the cover element. In some embodiments, the inner surface of the cover head is opposite to the outer surface of the cover head.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates an example perspective view of an example respiratory protective device in accordance with some example embodiments described herein;

FIG. 2A illustrates an example exploded view of an example mask component in accordance with some example embodiments described herein;

FIG. 2B illustrates another example exploded view of an example mask component in accordance with some example embodiments described herein;

FIG. 2C illustrates another example exploded view of an example mask component in accordance with some example embodiments described herein;

FIG. 2D illustrates an example back view of an example mask component in accordance with some example embodiments described herein;

FIG. 3 illustrates an example circuit diagram of an example respiratory protective device in accordance with some example embodiments described herein;

FIG. 4A illustrates an example perspective view of an example filtration component for an example respiratory protective device in accordance with some example embodiments described herein;

FIG. 4B illustrates another example perspective view of the example filtration component shown in FIG. 4A in accordance with some example embodiments described herein;

FIG. 4C illustrates another example perspective view of the example filtration component shown in FIG. 4A in accordance with some example embodiments described herein;

FIG. 4D illustrates an example exploded view of the example filtration component shown in FIG. 4A in accordance with some example embodiments described herein;

FIG. 4E illustrates some example elements of the example filtration component shown in FIG. 4A in accordance with some example embodiments described herein;

FIG. 4F illustrates an example cross-sectional view of the example filtration component shown in FIG. 4A in accordance with some example embodiments described herein;

FIG. 5 illustrates an example tube element in accordance with some example embodiments described herein;

FIG. 6 illustrates an example release film element in accordance with some example embodiments described herein;

FIG. 7 illustrates an example cover element in accordance with some example embodiments described herein;

FIG. 8 illustrates an example seal film element in accordance with some example embodiments described herein;

FIG. 9 illustrates an example method for assembling a filtration component for a respiratory protective device in accordance with some example embodiments described herein;

FIG. 10A illustrates an example filtration component for an example respiratory protective device in accordance with some example embodiments described herein;

FIG. 10B illustrates an example filtration component for an example respiratory protective device in accordance with some example embodiments described herein; and

FIG. 10C illustrates an example filtration component for an example respiratory protective device in accordance with some example embodiments described herein.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

Respiratory protective devices (such as, but not limited to, masks, respirators, and/or the like) can protect our health, especially in the COVID-19 pandemic. For example, wearing a respiratory protective device can help slow the spread of the virus, and people are recommended or required to wear masks in indoor public places and outdoors where there is a high risk of COVID-19 transmission (such as crowded events or large gatherings).

As described above, many respiratory protective devices do not provide any mechanism for incorporating dispersing elements, and there is a need for an improved filter design that keeps a dispersing element sealed within the filter and provides a long dispersing effect.

Various embodiments of the present disclosure overcome these technical challenges and difficulties. For example, various embodiments of the present disclosure provide an improved design for a filtration component with structure to contain the dispersing element. In some embodiments, the filtration component is shaped similar to a letter “D” and has a square lip (cut) at the bottom. The “D” shape for the filtration component allows the filtration component to easily fit on the respiratory protective device. In some embodiments, the filtration component has a hole at the center (formed by a center wall element) to accommodate the dispersing element container.

As such, an example filtration component in accordance with example embodiments of the present disclosure provide a high protection level. The example filtration component causes lower inhalation and exhalation resistance and without any leakage on the base of the example filtration component. The example filtration component provides a built-in slot for a NFC tag ring to be attached to the example filtration component, and is easy to install and to disassemble.

By incorporating the dispersing element in the example filtration component, an ecosystem for dispersing elements is created, as different manufacturing partners for the dispersing element can provide their own dispersing elements to be used in the example filtration component. For example, the dispersing elements can be used to provide health value. For example, a dispersing element can contain medicated vapors (such as VICKs) that enter the nose and mouth, which can start working in minutes to soothe coughs for easier breathing. The dispersing element can also provide scents to bring joy, relaxation or a sense of escape, thereby providing economic and social values. Additionally, various embodiments of the present disclosure can be distinguished from counterfeit products through the NFC tag ring, and improve the user experience as the dispersing element container is very small.

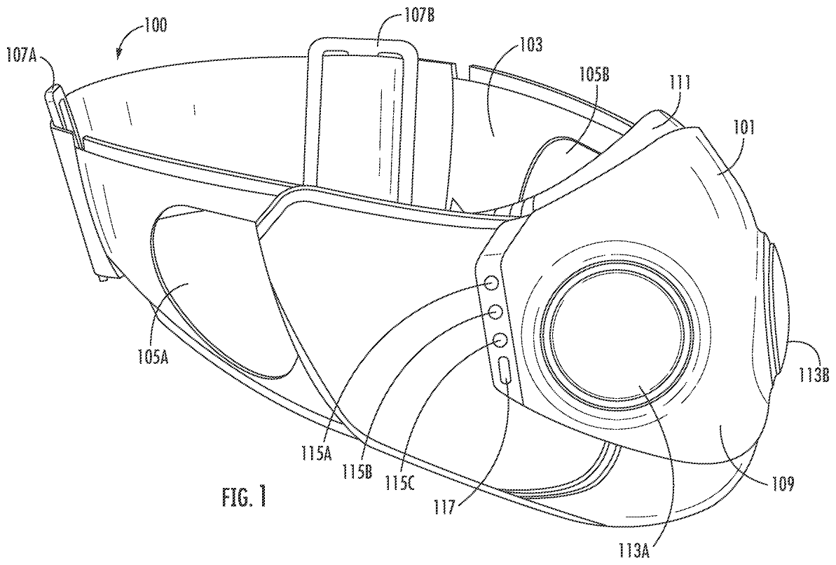

Referring now to FIG. 1, an example perspective view of an example respiratory protective device (also referred to as a respiratory protective equipment) 100 in accordance with some example embodiments described herein is illustrated.

In some embodiments, the example respiratory protective device 100 is in the form of a respirator or a mask. For example, as shown in FIG. 1, the example respiratory protective device 100 comprises a mask component 101 and a strap component 103.

In some embodiments, the strap component 103 may be in the form of a mask strap. For example, in some embodiments, the strap component 103 may comprise elastic material(s) such as, but not limited to, polymers, thermoplastic elastomer (TPE), and/or the like. In some embodiments, the elastic material may allow the example respiratory protective device 100 to be secured to a user's face.

In some embodiments, the strap component 103 may comprise an ear opening 105A and an ear opening 105B. When the example respiratory protective device 100 is worn by a user, the ear opening 105A and the ear opening 105B may allow the user's left ear and the right ear to pass through.

In some embodiments, the strap component 103 may be inserted through one or more strap bucket components (such as a strap bucket component 107A and a strap bucket component 107B as shown in FIG. 1). In some embodiments, the one or more strap bucket components may be in the form of one or more buckles that include, but not limited to, a tri-glide buckle), and may allow a user to adjust the length of the strap component 103 so that the example respiratory protective device 100 can be secured to a user's face.

In some embodiments, the mask component 101 is connected to the strap component 103. For example, a first end of the strap component 103 is connected to a first end of the mask component 101, and a second end of the strap component 103 is connected to a second of the mask component 101. In this example, the first end of the mask component 101 is opposite to the second end of the mask component 101. In the example shown in FIG. 1, an end of the strap component 103 may be secured to the mask component 101 via a fastener component 117 (such as, but not limited to, a snap button).

In some embodiments, the mask component 101 may be in the form of a mask or a respirator. For example, as shown in FIG. 1, the mask component 101 may comprise an outer shell component 109 and a face seal component 111.

In some embodiments, when the example respiratory protective device 100 is worn by a user, an outer surface of the outer shell component 109 is exposed to the outside environment. In some embodiments, the face seal component 111 is attached to and extends from a periphery and/or edge of the outer shell component 109 (or an inner shell component of the mask component as described herein).

In particular, the face seal component 111 may comprise soft material such as, but not limited to, silica gel. In some embodiments, when the example respiratory protective device 100 is worn by a user, the face seal component 111 is in contact with the user's face, and may seal the example respiratory protective device 100 to at least a portion of a user's face. As described above, the example respiratory protective device 100 includes strap component 103 that allows the example respiratory protective device 100 to be secured to the user's face. As such, the face seal component 111 can create at least partially enclosed (or entirely enclosed) space between at least a portion of the user's face (e.g. mouth, nostrils, etc.), details of which are described herein.

In some embodiments, the mask component 101 comprises one or more puck components that cover one or more inhalation filtration components of the example respiratory protective device 100. For example, as shown in FIG. 1, the example respiratory protective device 100 comprises a first puck component 113A that is disposed on a left side of the outer shell component 109 and a second puck component 113B that is disposed on a right side of the outer shell component 109. In such an example, the first puck component 113A covers a first inhalation filtration component that is disposed on the left side of the mask component 101, and the second puck component 113B covers a second inhalation filtration component that is disposed on the right side of the mask component 101, details of which are described herein.

In some embodiments, the mask component 101 comprises one or more key components (such as, but not limited to, the key component 115A, the key component 115B, and the key component 115C) that may allow a user to manually control the operations of the fan component of the mask component 101 and/or other devices (such as, but not limited to, earphones) that are in electronic communication with the example respiratory protective device 100.

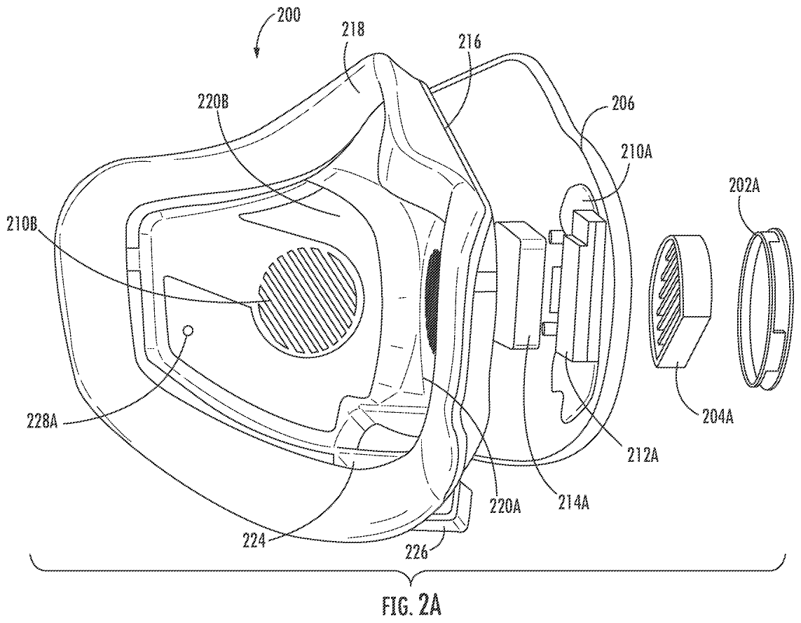

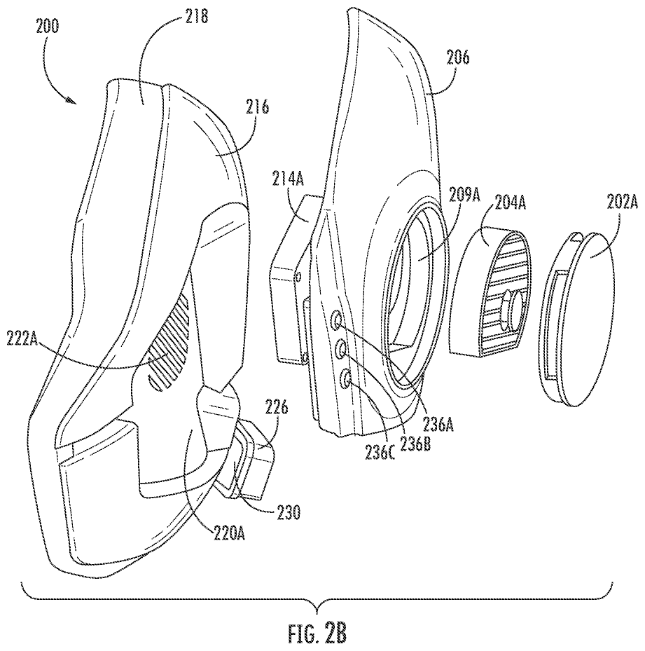

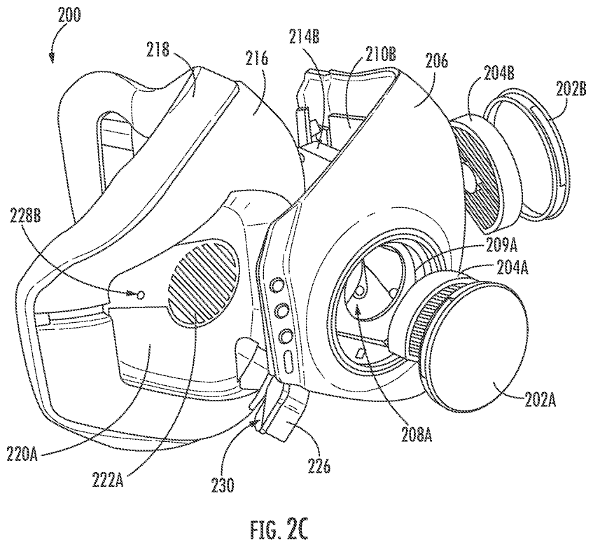

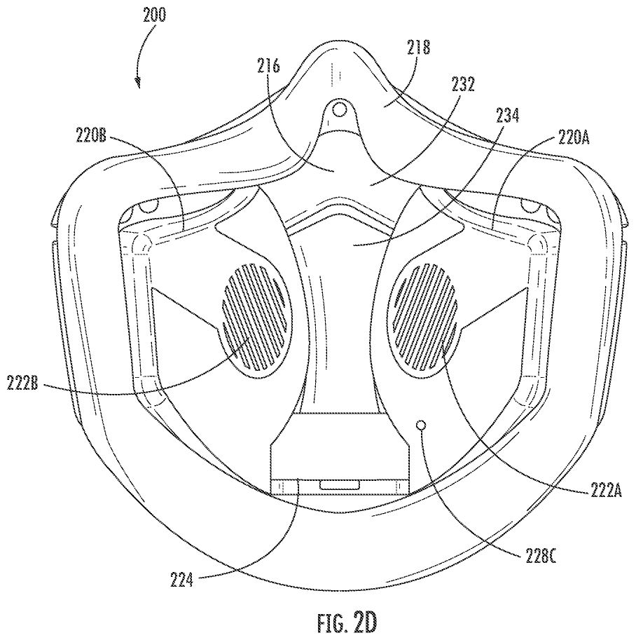

Referring now to FIG. 2A, FIG. 2B, FIG. 2C, and FIG. 2D, examples views of an example mask component 200 in accordance with some example embodiments described herein are illustrated. In particular, FIG. 2A to FIG. 2C illustrate example exploded views of the example mask component 200, and FIG. 2D illustrates an example back view of the example mask component 200.

As shown in FIG. 2A, the mask component 200 comprises an outer shell component 206 and an inner shell component 216.

In some embodiments, the inner shell component 216 may be in a shape that is based on the contour of the user's face. In particular, when the mask component 200 is worn by a user, at least a portion of the user's face (such as, but not limited to, mouth, nostrils) are housed within the inner shell component 216.

In some embodiments, the mask component 200 may comprise a face seal component 218. In some embodiments, the face seal component 218 is attached to and extends from a periphery and/or edge of the inner shell component 216. Similar to the face seal component 111 described above in connection with FIG. 1, the face seal component 216 may comprise soft material such as, but not limited to, silica gel.

In some embodiments, when the mask component 200 is worn by a user, the face seal component 218 and an inner surface of the inner shell component 216 create an enclosed space on at least a portion of the user's face (e.g. on the mouth, nostrils, etc.).

Similar to the inner shell component 216 described above, the shape of the outer shell component 206 may be based on a contour of the user's face. In some embodiments, when the mask component 200 is assembled, the inner surface of the outer shell component 206 is secured to an outer surface of the inner shell component 216. In some embodiments, the inner shell component 216 may comprise one or more indentation portions on the outer surface of inner shell component 216.

For example, referring now to FIG. 2B, the inner shell component 216 may comprise inner shell indentation portions such as, but not limited to, an inner shell indentation portion 220A that is on a left side of the mask component 200 and an inner shell indentation portion 220B that is on a right side of the mask component 200. In particular, each of the inner shell indentation portion 220A and inner shell indentation portion 220B may be sunken or depressed from the outer surface of inner shell component 216. As such, when the outer shell component 206 is secured to the inner shell component 216, the indentation portions may create space that houses electronic components.

Referring back to FIG. 2A, in some embodiments, one or more circuit board components (such as, but not limited to, a circuit board component 210A), one or more charging circuit components (such as, but not limited to, a charging circuit component 212A), and one or more fan components (such as, but not limited to, a fan component 214A) may be disposed in the space that is defined by the inner shell indentation portion 220A and the inner surface of the outer shell component 206. Similarly, one or more circuit board components (such as, but not limited to, a circuit board component 210B), one or more charging circuit components, and one or more fan components (such as, but not limited to, a fan component 214B) may be disposed in the space that is defined by the inner shell indentation portion 220B and the inner surface of the outer shell component 206. For example, the fan component 214A may be disposed on the right side of the example respiratory protective device 200 and the fan component 214B may be disposed on the left side of the example respiratory protective device 200.

In some embodiments, the circuit board component 210A comprises a circuit board (such as, but not limited to a printed circuit board (PCB)) where other electronic components can be secured to and be in electronic communications with one another. For example, a controller component, the charging circuit component 212A and the fan component 214A may be secured to the circuit board component 210A and be in electronic communication with one another.

In some embodiments, the charging circuit component 212A may comprise a charging circuit and/or a battery that supplies power to the controller component and/or the fan component 214A. For example, the charging circuit may include a Universal Serial Bus (USB) charger circuit that is connected to a rechargeable battery.

In some embodiments, the fan component 214A may comprise an electric fan. In some embodiments, the electric fan of the fan component 214A may operate at different rotation speeds. For example, the fan component 214A may be a stepped fan that provides different, predetermined settings for the rotation speeds. Additionally, or alternatively, the fan component 214A may be a stepless fan that enables continuous adjustment of the rotation speed.

In some embodiments, the electric fan of the fan component 214A may operate at different rotational directions. For example, the fan component 214A may operate in a forward direction or a reverse direction. As an example, when the fan component 214A operates in the forward rotational direction, the electric fan of the fan component 214A may rotate counter-clockwise (when viewing from a user wearing the mask component 200) and/or may operate as a blower that draws air from outside the mask component 200 to inside the mask component 200. As another example, when the fan component 214A operates in the reverse rotational direction, the electric fan of the fan component 214A may rotate clockwise (when viewing from a user wearing the mask component 200) and/or may operate as an exhaust/ventilation fan that draws air from inside the mask component 200 to outside the mask component 200.

In some embodiments, the start time, the stop time, the rotational directions (e.g. forward direction or reverse direction) and/or the rotation speed of the electric fan of the fan component 214A may be controlled and/or adjusted by the controller component.

For example, the controller component may transmit a forward rotation start signal to the fan component 214A that causes the fan component 214A to start forward rotation (e.g. start operating as a blower that draws air from outside the mask component 200 towards inside the mask component 200). In some embodiments, the forward rotation start signal may include a forward rotation speed value that indicates the speed for the fan component 214A. Additionally, or alternatively, the controller component may transmit a forward rotation stop signal to the fan component 214A that causes the fan component 214A to stop forward rotation.

Additionally, or alternatively, the controller component may transmit a reverse rotation start signal to the fan component 214A that causes the fan component 214A to start reverse rotation (e.g. start operating as an exhaust fan that draws air from inside the mask component 200 towards outside the mask component 200). In some embodiments, the reverse rotation start signal may include a reverse rotation speed value that indicates the speed for the fan component 214A. Additionally, or alternatively, the controller component may transmit a reverse rotation stop signal to the fan component 214A that causes the fan component 214A to stop reverse rotation.

Referring now to FIG. 2C, the mask component 200 may comprise one or more inhalation filtration components (such as, but not limited to, inhalation filtration component 204A and inhalation filtration component 204B) and one or more puck components (such as, but not limited to puck component 202A and puck component 202B).

In some embodiments, each of the one or more inhalation filtration components may comprise a filter media element that comprise filter material for filtering air. Examples of filter material include, but are not limited to, HEPA filters. In some embodiments, each of the one or more puck components may be positioned to cover one of the inhalation filtration components so as to prolong the lifespan of the mask component 200. For example, the puck component 202A may cover the inhalation filtration component 204A, and the puck component 202B may cover the inhalation filtration component 204B.

As shown in FIG. 2C, the outer shell component 206 of the example mask component 200 may comprise one or more outer shell indentation portions (such as the outer shell indentation portion 209A). In particular, each of the outer shell indentation portion 209A may be sunken or depressed from the outer surface of outer shell component 206. In some embodiments, one or more inhalation filtration components may be disposed in the outer shell indentation portions. For example, as shown in FIG. 2C, an inhalation filtration component 204A is disposed in the outer shell indentation portion 209A.

In some embodiments, each of the one or more outer shell indentation portions may comprise an air inlet opening, and each of the one or more inner shell indentation portions may comprise one or more air inlet slots. In some embodiments, when the mask component 200 is assembled and in use, the air inlet opening on the outer shell indentation portion is aligned with the one or more air inlet slots on the inner shell indentation portion.

For example, as shown in FIG. 2C, the air inlet opening 208A on the outer shell indentation portion 209A of the outer shell component 206 is aligned with the air inlet slots 222A on the inner shell indentation portion 220A of the inner shell component 216.

In this example, when the mask component 200 is worn by a user and the user inhales, air is drawn from the outside environment and travels through the inhalation filtration component 204A, through the air inlet opening 208A, through the air inlet slots 222A, and arrive at the user's mouth or nostrils. As described above and shown in FIG. 2A and FIG. 2B, the fan component 214A is disposed on the inner shell indentation portion 220A (where the air inlet slots 222A are located). In some embodiments, when the user inhales, the fan component 214A may operate in a forward direction that draws air from outside the mask component 200 towards inside the mask component 200, thereby facilitating the inhaling of the user.

Referring now to FIG. 2D, an example back view of the example mask component 200. In particular, FIG. 2D illustrates the view of the example mask component 200 when it is worn by a user and viewed by the user.

As shown in FIG. 2D, the example mask component 200 may comprise air inlet slots 222A that are located on the middle right side of the inner shell component 216, and air inlet slots 222B that are located on the middle left side of the inner shell component 216. For example, the inner surface 232 of the inner shell component 216 may comprise a nose portion 234, where a user may put his or her nose when the mask component 200 is worn. In this example, the air inlet slots 222A may be located to the right of the nose portion 234, and the air inlet slots 222B may be located to the left of the nose portion 234.

In some embodiments, the example mask component 200 may comprise an outlet opening 224 that is on a middle bottom portion of the inner shell component 216. In some embodiments, the outlet opening 224 may be located corresponding to the position of the user's mouth. For example, when a user exhales, the breath may be released through the outlet opening 224.

As shown in FIG. 2A to FIG. 2C, an exhalation filtration component 226 may be connected to the inner shell component 216 at the outlet opening 224. For example, the exhalation filtration component 226 may cover the outlet opening 224. In some embodiments, the exhalation filtration component 226 may comprise a filter media element that comprise filter material for filtering air. Examples of filter material include, but are not limited to, HEPA filters. As such, the breath that is exhaled by the user may be filtered before it is released from inside the mask component 200 to the outside environment.

In some embodiments, the exhalation filtration component 226 may comprise an air quality sensor component 230 that at least partially covers the outlet opening 224 of the inner shell component 216. The air quality sensor component 230 may comprise an air quality sensor that may, for example but not limited to, detect particulate matters in the outer environment, in the enclosed space and/or in the breath exhaled by the user. Examples of the air quality sensor component 230 include, but are not limited to, metal oxide sensors, electrochemical sensors, photo ionization detectors, optical particle counters, optical sensors, and/or the like. In some embodiments, the air quality sensor component 230 is in electronic communication with the controller component, and may transmit air quality indications to the controller component indicating the detected air quality.

In some embodiments, the mask component 200 may comprise one or more pressure sensor components. As described above and as shown in FIG. 2B, when the mask component 200 is worn by a user, the face seal component 218 and an inner surface 232 of the inner shell component 216 create an enclosed space on at least a portion of the user's face (e.g. on the mouth, nostrils, etc.). In some embodiments, a pressure sensor component may comprise a pressure sensor that detects the air pressure within this enclosed space. Examples of the pressure sensor components include, but are not limited to, resistive air pressure transducer or strain gauge, capacitive air pressure transducer, inductive air pressure transducer, and/or the like.

For example, as shown in FIG. 2A, a pressure sensor component 228A may be disposed on an inner surface of the inner shell component 216. Additionally, or alternatively, as shown in FIG. 2C, a pressure sensor component 228B may be disposed on the inner shell indentation portion 220A of the inner shell component 216. Additionally, or alternatively, as shown in FIG. 2D, a pressure sensor component 228C may be disposed on the inner surface of the inner shell component 216. The pressure sensor component 228A, the pressure sensor component 228B, and/or the pressure sensor component 228C may detect the air pressure within the enclosed space defined by the face seal component 218 and the inner shell component 216 on at least a portion of the user's face.

In some embodiments, the one or more pressure sensor components are in electronic communication with the controller component, and may transmit air pressure indications to the controller component indicating the detected air pressure. For example, each of the air pressure indications may comprise an air pressure value that corresponds to the air pressure in the enclosed space as defined by the face seal component 218 and the inner shell component 216.

While the description above provides an example mask component, it is noted that the scope of the present disclosure is not limited to the description above. In some examples, an example mask component may comprise one or more additional and/or alternative elements. For example, an example mask component may comprise less than two or more than two fan components. Additionally, or alternatively, an example mask component may comprise less than two or more than two inhalation filtration components.

In some embodiments, mask component 200 may include one or more key components, such as, but not limited to, a key component 236A, a key component 236B, and a key component 236C. In some embodiments, the one or more key components may be disposed on an outer surface of the outer shell component 206. Each of the one or more key components may provide a button that allow a user to control and/or adjust the operations of various electronic components described herein (such as, but not limited to, fan components, earphones, and/or the like.)

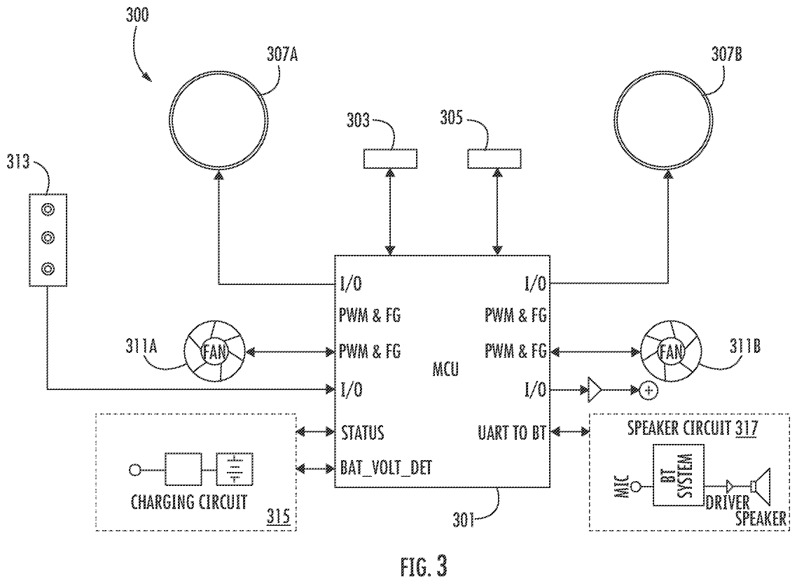

Referring now to FIG. 3, an example circuit diagram of an example respiratory protective device 300 in accordance with some example embodiments described herein is illustrated. In particular, FIG. 3 illustrates example electronic components of an example respiratory protective device in accordance with various example embodiments of the present disclosure.

As shown in FIG. 3, the example respiratory protective device 300 may comprise a controller component 301 that is in electronic communications with other components such as, but not limited to, the pressure sensor component 303, the air quality sensor component 305, a light 307A and a light 307B that are disposed on one or more puck components, fan component 311A, fan component 311B, key components 313, and/or the speaker circuit 317.

In some embodiments, the controller component 301 may be embodied as means including one or more microprocessors with accompanying digital signal processor(s), one or more processor(s) without an accompanying digital signal processor, one or more coprocessors, one or more multicore processors, one or more controllers, processors, one or more computers, various other processing elements including integrated circuits such as, for example, an application specific integrated circuit (ASIC), programmable logic controller (PLC) or field programmable gate array (FPGA), or some combination thereof. Accordingly, although illustrated in FIG. 3 as a single processor, in an embodiment, the controller component 301 may include a plurality of processors and signal processing modules. The plurality of processors may be in operative communication with each other and may be collectively configured to perform one or more functionalities as described herein. In an example embodiment, the controller component 301 may be configured to execute instructions stored in a memory circuitry or otherwise accessible to the controller component.

Whether configured by hardware, firmware/software methods, or by a combination thereof, the controller component 301 may include an entity capable of performing operations according to embodiments of the present disclosure while configured accordingly. Thus, for example, when the controller component 301 is embodied as an ASIC, PLC, FPGA or the like, the controller component 301 may include specifically configured hardware for conducting one or more operations described herein. Alternatively, as another example, when the controller component 301 is embodied as an executor of instructions, such as may be stored in the memory circuitry, the instructions may specifically configure the controller component 301 to perform one or more algorithms and operations described herein.

Thus, the controller component 301 used herein may refer to a programmable microprocessor, microcomputer or multiple processor chip or chips that can be configured by software instructions (applications) to perform a variety of functions, including the functions of the various embodiments described above.

In some embodiments, the memory circuitry may include suitable logic, circuitry, and/or interfaces that are adapted to store a set of instructions that is executable by the controller component 301 to perform predetermined operations. Some of the commonly known memory implementations include, but are not limited to, a hard disk, random access memory, cache memory, read only memory (ROM), erasable programmable read-only memory (EPROM) & electrically erasable programmable read-only memory (EEPROM), flash memory, magnetic cassettes, magnetic tape, magnetic disk storage or other magnetic storage devices, a compact disc read only memory (CD-ROM), digital versatile disc read only memory (DVD-ROM), an optical disc, circuitry configured to store information, or some combination thereof. In an example embodiment, the memory circuitry may be integrated with the controller component 301 on a single chip, without departing from the scope of the disclosure.

In some embodiments, the pressure sensor component 303 may transmit air pressure indications to the controller component 301. As described above, each of the air pressure indications may comprise an air pressure value that corresponds to the air pressure in the enclosed space as defined by the face seal component 218 and the inner shell component 216.

In some embodiments, the air quality sensor component 305 may transmit air quality indications to the controller component 301. As described above, the air quality indications may indicate a quality of the air in the outer environment, in the enclosed space and/or in the breath exhaled by the user.

In some embodiments, the controller component 301 may transmit control signals to the light 307A and/or the light 307B so as to adjust the color and/or intensity of the light emitted by the light 307A and/or the light 307B.

In some embodiments, the controller component 301 may transmit forward rotation start signals to the fan component 311A and/or the fan component 311B to cause the fan component 311A and/or the fan component 311B to start forward rotation. In some embodiments, the controller component 301 may transmit forward rotation stop signals to the fan component 311A and/or the fan component 311B to cause the fan component 311A and/or the fan component 311B to stop forward rotation.

In some embodiments, the controller component 301 may transmit reverse rotation start signals to the fan component 311A and/or the fan component 311B to cause the fan component 311A and/or the fan component 311B to start reverse rotation. In some embodiments, the controller component 301 may transmit reverse rotation stop signals to the fan component 311A and/or the fan component 311B to cause the fan component 311A and/or the fan component 311B to stop reverse rotation.

In some embodiments, the controller component 301 is in electronic communication with the key components 313. For example, when a user presses a button on the key components 313, the key components 313 may transmit a signal to the controller component 301.

In some embodiments, the controller component 301 is in electronic communication with the speaker circuit 317. For example, the controller component 301 may transmit control signals to an earphone in the speaker circuit 317 so as to adjust volume, noise canceling mode, and/or the like of the earphone.

In some embodiments, the charging circuit 315 supplies power to controller component 301 and one or more other electronic components shown in FIG. 3 (such as, but not limited to, the fan component 311A and the fan component 311B).

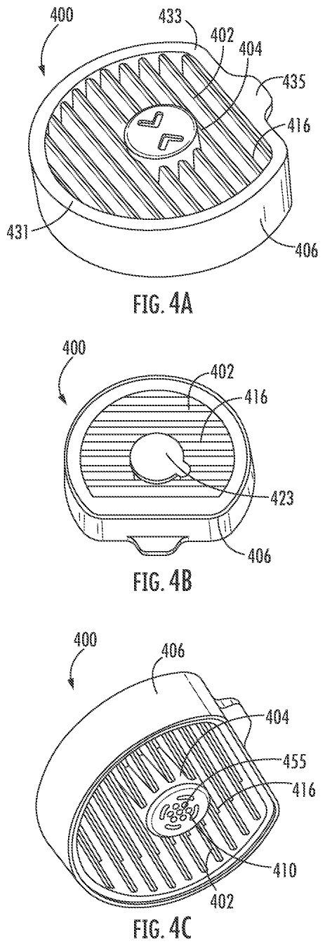

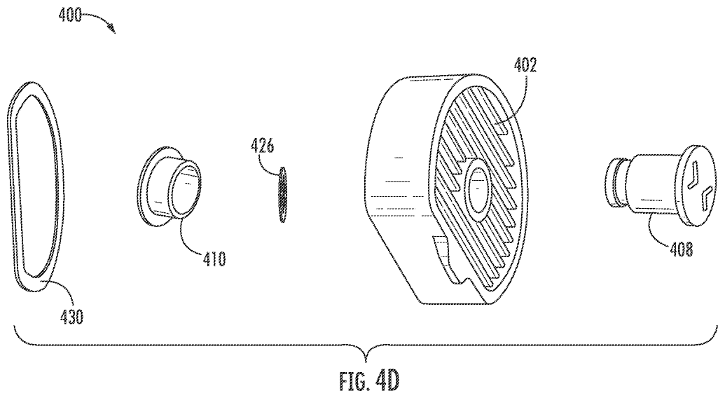

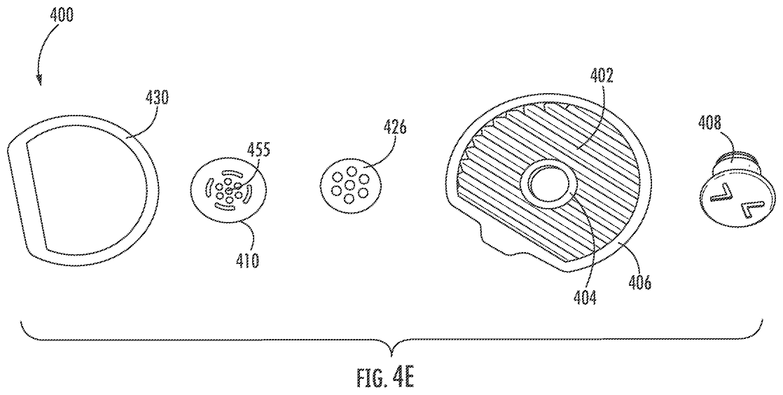

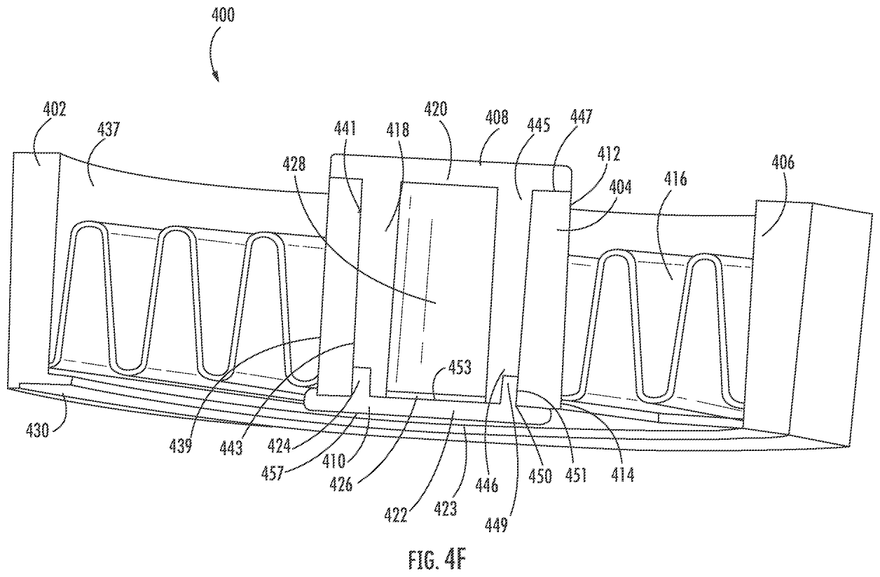

As described above, an example respiratory protective device may comprise one or more inhalation filtration components and/or one or more exhalation filtration components. Referring now to FIG. 4A, FIG. 4B, FIG. 4C, FIG. 4D, FIG. 4E, and FIG. 4F, an example filtration component 400 for a respiratory protective device is illustrated. In some embodiments, the example filtration component 400 is an example inhalation filtration component. In some embodiments, the example filtration component 400 is an example exhalation filtration component.

In particular, FIG. 4A illustrates an example perspective view from a front of the example filtration component 400. FIG. 4B illustrates another example perspective view from a back of the example filtration component 400 that includes a seal film element 423. FIG. 4C illustrates another example perspective view from the back of the example filtration component 400 without the seal film element.

In the example views shown in FIG. 4A, FIG. 4B, and FIG. 4C, the example filtration component 400 comprises a filter body 402. In some embodiments, the filter body 402 comprises a center wall element 404 and a periphery wall element 406. In some embodiments, the center wall element 404 is positioned within the periphery wall element 406. In some embodiments, the center wall element 404 is at the center of the periphery wall element 406.

In some embodiments, the center wall element 404 is in a shape similar to an annular cylinder shape. In some embodiments, the center wall element 404 defines a center hole of the example filtration component 400. In some embodiments, the center wall element 404 comprises material(s) such as, but not limited to, thermoplastic elastomer (TPE) material.

In some embodiments, the periphery wall element 406 is in a shape similar to an annular cylinder shape. In some embodiments, the periphery wall element 406 comprises material(s) such as, but not limited to, TPE material.

In some embodiments, the periphery wall element 406 may be molded into a shape similar to a three dimensional letter “D” shape. For example, as shown in FIG. 4A, the periphery wall element 406 comprises an arc portion 431, a straight portion 433, and a handle portion 435.

In some embodiments, a horizontal cross section of the arc portion 431 defines a part of the circumference of a circle. In some embodiments, the arc portion 431 comprises a first end and a second end.

In some embodiments, a horizontal cross section of the straight portion 433 defines a straight line. In some embodiments, the straight portion 433 is connected to the arc portion 431. For example, a first end of the straight portion 433 is connected to a first end of the arc portion 431, and a second end of the straight portion 433 is connected to a second end of the arc portion 431.

In some embodiments, the handle portion 435 protrudes from an edge of the straight portion 433. In some embodiments, the handle portion 435 provides a mechanism for the example filtration component 400 to be secured within an example respiratory protective device (for example, secured on an inner shell indentation portion of an inner shell of the example respiratory protective device). In some embodiments, the handle portion 435 may be in a shape similar to a square shape.

In some embodiments, the filter body 402 further comprises a filter media element 416. In some embodiments, the filter media element 416 is secured between the periphery wall element 406 and the center wall element 404. For example, the filter media element 416 is secured between an inner surface 437 of the periphery wall element 406 and the outer surface 439 of the center wall element 404. In some embodiments, the filter media element 416 may comprise filter material such as, but not limited to, HEPA filter materials. In the example shown in FIG. 4A, FIG. 4B, and FIG. 4C, the filter media element 416 may be pleated and/or folded into a zig-zag shape that increases the surface area of the HEPA filter materials and allows a large area of HEPA filter materials to be used.

In some embodiments, the filtration component 400 comprises a dispersing element container. In some embodiments, the dispersing element container is secured within the center wall element 404. For example, referring now to FIG. 4D, FIG. 4E, and FIG. 4F, example components of an example dispersing element container are illustrated.

As shown in FIG. 4D and FIG. 4E, in some embodiments, the dispersing element container comprises a tube element 408 and a cover element 410.

In some embodiments, the tube element 408 comprises material(s) that provide chemical resistance characteristics. For example, the tube element 408 can provide chemical resistance to perfume or cream. In some embodiments, the tube element 408 comprises materials such as, but not limited to, polypropylene (PP) material. In some embodiments, the tube element 408 provides functions such as, but not limited to, containing the dispersing element such as scents elements while displaying a logo on the outer surface of the tube head of the tube element 408.

In some embodiments, the cover element 410 comprises material(s) that provide chemical resistance characteristics. For example, the cover element 410 comprises materials such as, but not limited to, PP material. In some embodiments, the cover element 410 provides functions such as scent release through openings on the cover element 410, details of which are described herein.

In some embodiments, the tube element 408 is fastened to the cover element 410. As described herein, the tube element 408 may be fixed to the cover element 410 through interference fit and/or glue adhesive such that they cannot be separated.

In some embodiments, the dispersing element container comprises a release film element 426.

In some embodiments, the release film element 426 comprises materials that are water and oil proof, and provide control release functions. For example, the release film element 426 comprises materials such as, but not limited to, microporous PTFE. In some embodiments, the release film element 426 is fixed to the inner surface of the cover element 410 so as to prevent leakage of the dispersing element. For example, the release film element 426 can be attached to the cover element 410 through glue adhesion and/or be structurally fixed to the cover element 410. In some embodiments, the release film element 426 may provide functions such as controlling scent releasing.

In some embodiments, the example filtration component 400 further comprises a near-field communication (NFC) element 430.

FIG. 4F illustrates an example vertical cross-sectional view of the example filtration component 400.

In the example shown in FIG. 4F, the center wall element 404 comprises a distal end 412 and a proximal end 414. In some embodiments, the proximal end 414 of the center wall element 404 is opposite to the distal end 412 of the center wall element 404. In some embodiments, when an example respiratory protective device in accordance with example embodiments of the present disclosure is worn by a user, the distal end 412 of the center wall element 404 is further away from the user than the proximal end 414 of the center wall element 404.

In some embodiments, the dispersing element container comprises the tube element 408. In some embodiments, the tube element 408 is positioned at the distal end 412 of the center wall element 404. In some embodiments, the tube element 408 further comprises a tube body 418 and a tube head 420.

In some embodiments, the tube body 418 is in a shape similar to an annular cylinder shape. For example, the tube body 418 comprises a distal end 445 and a proximal end 446. In some embodiments, the proximal end 446 of the tube body 418 is opposite to the distal end 445 of the tube body 418. In some embodiments, when an example respiratory protective device in accordance with example embodiments of the present disclosure is worn by a user, the distal end 445 of the tube body 418 is further away from the user than the proximal end 446 of the tube body 418.

In some embodiments, the tube body 418 provides a housing for the dispersing element, details of which are described herein.

In some embodiments, the tube head 420 is in a shape similar to a cylinder shape. In some embodiments, the tube head 420 seals the distal end 445 of the tube body 418. For example, the tube head 420 completely covers the opening defined at the distal end 445 of the tube body 418. In some embodiments, the outer surface of the tube head 420 may display a logo, a label, or a branding.

Referring now to FIG. 5, an example tube element 500 is illustrated. In the example shown in FIG. 5, the example tube element 500 comprises a tube body 503 and a tube head 501.

Referring back to FIG. 4F, the dispersing element container comprises the cover element 410. In some embodiments, the cover element 410 is positioned at the proximal end 414 of the center wall element 404. In some embodiments, the cover element 410 comprises a cover body 424 and a cover head 422.

In some embodiments, the cover body 424 is in a shape similar to an annular cylinder shape. For example, the cover body 424 comprises a distal end 449 and a proximal end 450. In some embodiments, the proximal end of the cover body 424 is opposite to the distal end 449 of the cover body 424.

In some embodiments, when an example respiratory protective device in accordance with example embodiments of the present disclosure is worn by a user, the distal end 449 of the cover body 424 is further away from the user than the proximal end 450 of the cover body 424.

In some embodiments, the cover head 422 is in a shape similar to a cylinder shape. In some embodiments, the cover head 422 at least particularly covers the proximal end 450 of the cover body 424. For example, in some embodiments, the cover head 422 of the cover element 410 defines a plurality of openings 455 (as shown in FIG. 4C).

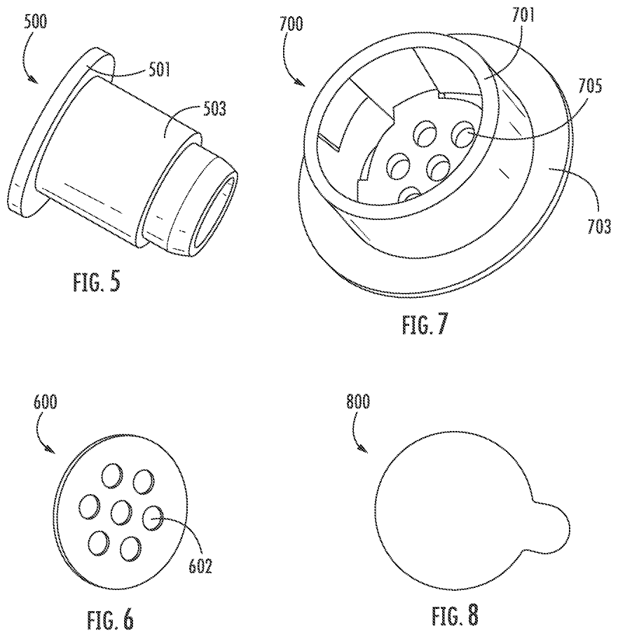

Referring now to FIG. 7, an example cover element 700 is illustrated. In the example shown in FIG. 7, the example cover element 700 comprises a cover body 701 and a cover head 703. As shown, the cover head 703 comprises a plurality of openings 705 that allow scent molecules from a dispersing element to pass through.

Referring back to FIG. 4F, the dispersing element container comprises the release film element 426. In some embodiments, the release film element 426 is secured to the inner surface 453 of the cover head 422 of the cover element 410. For example, the release film element 426 is attached to the inner surface 453 of the cover head 422 through an adhesive glue.

In some embodiments, the release film element 426 comprises microporous material. For example, the microporous material comprises materials(s) such as, but not limited to, polytetrafluoroethylene (PTFE).

Referring now to FIG. 6, an example release film element 600 is illustrated. In the example shown in FIG. 6, the example release film element 600 comprises a plurality of openings 602 that allow scent molecules from a dispersing element to pass through.

Referring back to FIG. 4F, the dispersing element container comprises the seal film element 423.

In some embodiments, the seal film element 423 is attached to an outer surface 457 of the cover head 422 of the cover element 410. In some embodiments, the seal film element 423 covers the plurality of openings 455 of the cover element 410 and prevents scent molecules from the dispersing element to be released.

In some embodiments, the seal film element 423 is an aluminum laminated film that functions as a gas barrier for scent sealing. Additionally, or alternatively, the seal film element 423 may comprise materials such as, but not limited to, polyethylene terephthalate (PET) and/or PP. In some embodiments, the seal film element 423 may provide function as a gas barrier. In some embodiments, the seal film element 423 may be attached to the cover element through self-adhesion, and can be torn away before the example filtration component 400 is used.

Referring now to FIG. 8, an example seal film element 800 is illustrated.

Referring back to FIG. 4F, the tube element 408 is fastened to the cover element 410. For example, the distal end 449 of the cover body 424 of the cover element 410 is fastened to a proximal end 446 of the tube body 418 of the tube element 408. In some embodiments, the distal end 449 of the cover body 424 is secured to the proximal end 446 of the tube body 418 via at least one of an interference fit or an adhesive glue. Additionally, or alternatively, the distal end 449 of the cover body 424 is secured to the proximal end 446 of the tube body 418 through other mechanisms.

In some embodiments, the tube element 408 and the cover element 410 are secured to the center wall element 404. In some embodiments, the size of the tube element 408 and the size of the cover element 410 are determined based on the size of the center wall element 404, so that the tube element 408 and the cover element 410 can fit to the center wall element 404 and cannot be moved or be removed from the center wall element 404.

For example, a periphery portion of an inner surface 447 of the tube head 420 of the tube element 408 is in contact with the distal end 412 of the center wall element 404. Additionally, or alternatively, an outer surface 441 of the tube body 418 is in contact with an inner surface 443 of the center wall element 404. Additionally, or alternatively, an outer surface 451 of the cover body 424 and a periphery portion of an inner surface 453 of the cover head 422 are in contact with the proximal end 414 of the center wall element 404.

In some embodiments, the filtration component 400 further comprises the NFC element 430. In some embodiments, the NFC element 430 is attached to a surface of the periphery wall element 406. In some embodiments, the NFC element 430 may store information such as, but not limited to, a serial number of the filtration component 400 so as to authenticate the filtration component 400.

In some embodiments, the filtration component 400 further comprises a dispersing element that is disposed within the dispersing element container. For example, the dispersing element is disposed within an enclosed space 428 that is defined by an inner surface of the tube body 418 of the tube element 408 and between the release film element 426 and the tube head 420 of the tube element 408. In some embodiments, the dispersing element disperses element to a user of the respiratory protective device after the seal film element is removed. For example, the dispersing element may disperse element to the user to sooth coughs, bring joy or relaxation, and so on along the breathing of the user.

In some embodiments, the dispersing element comprises fragrance material. For example, the fragrance material 604 may comprise fragrance oil, essential oils, and/or the like. Additionally, or alternatively, the fragrance material 604 may comprise specifically scented ingredients. For example, the fragrance material 604 may comprise materials such as, but not limited to, cypress, mint, lemon, jasmine, lavender, eucalyptus, lemon, lavender, sandalwood, grapefruit, tea, and/or the like. Additionally, or alternatively, the dispersing element may comprise medicated vapors that may soothe coughs and facilitate easier breathing. Additionally, or alternatively, the dispersing element may comprise chemicals such as cannabidiol.

In some examples, when the example filtration component 400 is assembled, the seal film element 423 is attached to the outer surface 457 of the cover head 422 of the cover element 410 and covers the plurality of openings 455 of the cover element 410 to prevent scent molecules from the dispersing element to be released. When the example filtration component 400 is used by a user (for example, when the user puts on an example respiratory protective device that includes the example filtration component 400), the user may remove the seal film element 423. As the user inhales through the example filtration component 400, scent molecules from the dispersing element can be release through pores in the microporous material of the release film element 426 and/or the of openings 602 of the release film element 600, as well as the openings 455 of the cover element 410, and arrive at the respiratory system of the user.

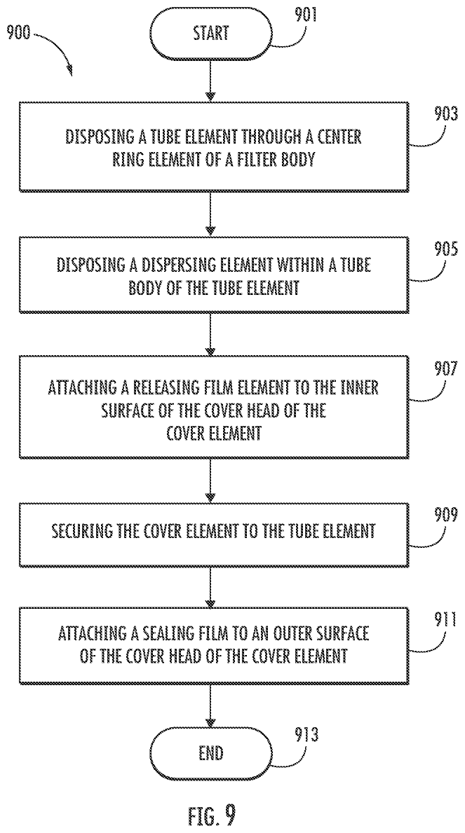

Referring now to FIG. 9, an example method 900 is illustrated. In particular, the example method 900 illustrates example steps/operations of assembling an example filtration component for a respiratory protective device in accordance with some example embodiments described herein.

In FIG. 9, the example method 900 starts at step/operation 901. In some embodiments, subsequent to step/operation 901, the example method 900 proceeds to step/operation 903. At step/operation 903, the example method 900 comprises disposing a tube element through a center wall element of a filter body.

As described above, the filter body in accordance with examples of the present disclosure comprises a center wall element and a periphery wall element. In some embodiments, the center wall element is positioned within the periphery wall element.

As described above, the tube element comprises a tube body and a tube cover. In some embodiments, the tube cover seals a distal end of the tube body. In some embodiments, a periphery portion of an inner surface of the tube head of the tube element is in contact with the distal end of the center wall element. Additionally, or alternatively, an outer surface of the tube body is in contact with an inner surface of the center wall element.

Referring back to FIG. 9, subsequent to step/operation 903, the example method 900 proceeds to step/operation 905. At step/operation 905, the example method 900 comprises disposing a dispersing element within the tube body of the tube element. For example, the dispersing element is disposed within a space that is defined by the inner lateral surface of the tube body of the tube element.

Referring back to FIG. 9, subsequent to step/operation 905, the example method 900 proceeds to step/operation 907. At step/operation 907, the example method 900 comprises attaching a release film element to the inner surface of the cover head of the cover element prior to securing the cover element to the tube element.

In some embodiments, the example method 900 attaches the release film element to the inner surface of the cover head of the cover element via an adhesive glue. Additionally, or alternatively, the example method 900 attaches the release film element to the inner surface of the cover head through other mechanisms.

Referring back to FIG. 9, subsequent to step/operation 907, the example method 900 proceeds to step/operation 909. At step/operation 909, the example method 900 comprises securing a cover element to the tube element.

In some embodiments, the cover element is secured to the tube element via at least one of an interference fit or an adhesive glue. In some embodiments, an inner surface of a cover head of the cover element is in contact with a proximal end of the center wall element.

Referring back to FIG. 9, subsequent to step/operation 909, the example method 900 proceeds to step/operation 911. At step/operation 911, the example method 900 comprises attaching a seal film element to an outer surface of the cover head of the cover element.

For example, the example method 900 attaches the seal film element to the outer surface of the cover head of the cover element to cover the plurality of openings. In some embodiments, the inner surface of the cover head is opposite to the outer surface of the cover head.

In some embodiments, subsequent to step/operation 911, the example method 900 proceeds to step/operation 913 and ends.

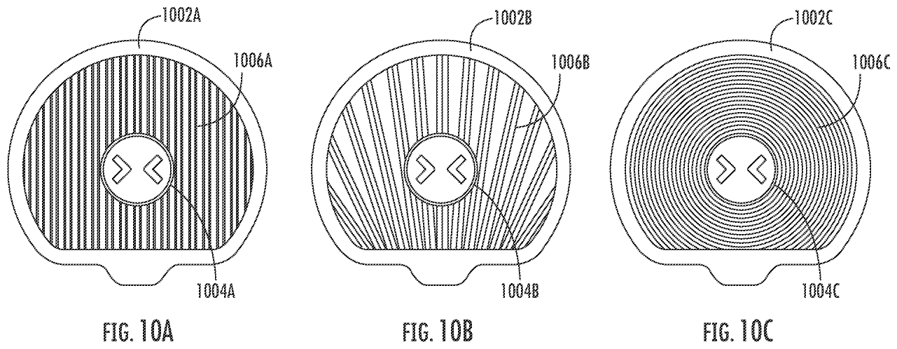

Referring now to FIG. 10A, FIG. 10B, and FIG. 10C, example filter media elements in accordance with various example embodiments of the present disclosure are illustrated.

As described above, an example filter media element may be secured between an inner surface of the periphery wall element and an outer surface of the center wall element. In some embodiments, an example filter media element may be pleated and/or folded so as to increase the surface area.

For example, in the example shown in FIG. 10A, the example filter media element 1006A is secured between the periphery wall element 1002A and the center wall element 1004A. In the example shown in FIG. 10A, the fold lines of the example filter media element 1006A are parallel lines.

In the example shown in FIG. 10B, the example filter media element 1006B is secured between the periphery wall element 1002B and the center wall element 1004B. In the example shown in FIG. 10B, the fold lines of the example filter media element 1006B are radial lines.

In the example shown in FIG. 10C, the example filter media element 1006C is secured between the periphery wall element 1002C and the center wall element 1004C. In the example shown in FIG. 10C, the fold lines of the example filter media element 1006C are radial circles.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A filtration component for a respiratory protective device, the filtration component comprising:
a filter body comprising a center wall element and a periphery wall element, and
a dispersing element container comprising a tube element fastened to a cover element, wherein the tube element is positioned at a distal end of the center wall element, wherein the cover element is positioned at a proximal end of the center wall element, wherein the proximal end of the center wall element is opposite to the distal end of the center wall element.

2. The filtration component of claim 1, wherein a filter media element is secured between an inner surface of the periphery wall element and an outer surface of the center wall element.

3. The filtration component of claim 1, wherein the tube element further comprises:
a tube body, wherein an outer surface of the tube body is in contact with an inner surface of the center wall element; and
a tube head, wherein the tube head seals a distal end of the tube body.

4. The filtration component of claim 3, wherein a periphery portion of an inner surface of the tube head is in contact with the distal end of the center wall element.

5. The filtration component of claim 3, wherein the cover element comprises:
a cover body, wherein a distal end of the cover body is fastened to a proximal end of the tube body; and
a cover head, wherein the cover head seals a proximal end of the cover body, wherein the proximal end of the cover body is opposite to the distal end of the cover body, wherein the proximal end of the tube body is opposite to the distal end of the tube body.

6. The filtration component of claim 5, wherein the distal end of the cover body is secured to the proximal end of the tube body via at least one of an interference fit or an adhesive glue.

7. The filtration component of claim 5, wherein an outer surface of the cover body and an inner surface of the cover head are in contact with the proximal end of the center wall element.

8. The filtration component of claim 5, wherein the cover head of the cover element defines a plurality of openings.

9. The filtration component of claim 8 further comprising:
a seal film element attached to an outer surface of the cover head of the cover element, wherein the seal film element covers the plurality of openings.

10. The filtration component of claim 9, wherein the dispersing element container further comprises:
a release film element secured to the inner surface of the cover head of the cover element.

11. The filtration component of claim 10, wherein the release film element comprises microporous material.

12. The filtration component of claim 11, wherein the microporous material comprises polytetrafluoroethylene (PTFE).

13. The filtration component of claim 10 further comprising:
a dispersing element disposed within an inner surface of the tube body of the tube element and between the release film element and the tube head of the tube element.

14. The filtration component of claim 13, wherein the dispersing element comprises fragrance material.

15. The filtration component of claim 1, further comprising:
a near-field communication (NFC) element attached to an inner surface of the periphery wall element.

16. The filtration component of claim 1, wherein the periphery wall element comprises an arc portion, a straight portion connected to the arc portion, and a handle portion protruding from an edge of the straight portion.

17. A method for assembling a filtration component for a respiratory protective device comprising:
disposing a tube element through a center wall element of a filter body, wherein a tube head of the tube element is in contact with a distal end of the center wall element;
disposing a dispersing element within a tube body of the tube element; and
securing a cover element to the tube element, wherein an inner surface of a cover head of the cover element is in contact with a proximal end of the center wall element.

18. The method of claim 17, wherein the cover element is secured to the tube element via at least one of an interference fit or an adhesive glue.

19. The method of claim 17, wherein, prior to securing the cover element to the tube element, the method further comprises:
attaching a release film element to the inner surface of the cover head of the cover element.

20. The method of claim 17, further comprising:
attaching a seal film element to an outer surface of the cover head of the cover element, wherein the inner surface of the cover head is opposite to the outer surface of the cover head.
